(19) United States
(12) Patent Application Publication
(10) Pub. No.: US 2004/0111281 A1
(43) Pub. Date: Jun. 10, 2004

(54) System and method for giving to charity

(76) Inventor: Glen Witter, Wausau, WI (US)

Correspondence Address: NATIONAL IP RIGHTS CENTER, LLC, SCOTT J. FIELDS, ESQ., 550 TOWNSHIP LINE ROAD, SUITE 400, BLUE BELL, PA, 19422, US

(21) Appl. No.: 10/316,202

(22) Filed: Dec. 10, 2002

(51) Int. Cl. G06F 17/60

(52) U.S. Cl. 705/1

(57) ABSTRACT

A method for donating the proceeds of the sale of physical assets to a charity comprising the following steps: providing an interface for a charity to register itself on the system; providing an interface for an end user donor to place an item for sale; providing an interface for a purchaser to purchase the item providing the donor with a receipt; and providing the intermediary charity with the proceeds which are then remitted to the designated charity.

### FIELD OF THE INVENTION

The present invention is directed to the field of charitable giving and specifically to the field of directing charitable donations to tax exempt §503(c) organizations. In particular, the present invention is directed to a system for automatically handling charitable giving and arranging for the payment of money collected from the sale of personal items and physical property.

### BACKGROUND OF THE INVENTION

In 1998 American charities received $174.5 billion in contributions. Of this amount, over 75%, or $134.8 billion, was contributed by individual donors. Buoyed by a strong economy and continuing gains in the stock market, individual donors have increased their giving to charitable causes by more than 40% in just the last several years, an average growth rate of 12% per year.

Growth in charitable giving has been even stronger since 1990, increasing at an annual rate of almost 14%. If individual donors' giving continues to grow at even two thirds this rate over the coming decade charitable giving by individuals could more than double. Approximately three out of every four dollars given to charity each year are given in the form of cash. There are a number of websites which facilitate the direct giving of money to charity.

Many people on the lower end of the financial spectrum are desirous of making charitable donations, but often lack cash. In many cases, such people often have personalty such as old clothes, furniture, electronics, memorables to sell and who could use proceeds from the sale of personal property to donate to charity. Many charities would desire the proceeds of such property but lack the resources, time and expense to both store and sell or dispose of such property which may be donated. Accordingly, charities frequently hold flea markets and the like to raise money. While such activities provide social interaction, they are time consuming, expensive and inefficient.

It would therefore be desirable to provide a system by which individuals can donate physical property and personal items which could be quickly sold, the sale of which could yield cash proceeds which can be donated to a directed charity.

It is an object of the present invention to provide a system and mechanism by which assets and property can be put on sale and sold and in which the transfer of funds to the owner to a directed charity.

It is a further object of the present invention to provide a system which facilitates the rapid transfer of assets for sale to third parties.

These and other objects of the present invention will become apparent from the detailed description which follows.

### SUMMARY OF THE INVENTION

The present invention is directed to a system to help donors more easily donate physical assets and property to charity, such as personal property and which provide the charity with the ability to sell the assets, and simultaneously encouraging them to increase their giving by the amount of their tax savings. The present invention thus facilitates the increase in the level of charitable contributions, by affording an easy mechanism for charities to derive proceeds from the sale of physical property such as personal items.

Beyond the increase in charitable giving resulting from increased efficiencies, non-profits also benefit from the fact that many individuals tend to be more generous when giving assets. The intermediate charity places the property online where a second user can then buy the property. The cash is paid to the second intermediary which then turns it over to a selected charity. The intermediary charity receives legal title to the the asset the same day it is given and can immediately sell it.

The processing entity, acting on behalf of the intermediary, issues a check to the selected charity, when the sale is made and the product shipped, minus any fees charged for the transaction process. A cover letter is attached to alert the charity of the donor's name and address (unless anonymity is requested), and to also state the purpose of the gift if stipulated by the donor.

The donor can designate create his charity of choice which can receive contributions from the intermediary charity at some future date (e.g., a set amount each month). By using the services of an intermediary charity and processing entity the charities can defer all asset transfers, rather than handling them themselves, allowing an intermediary charity to become their “back office” for asset transfers. The system utilizes the world wide web or global communications to advertise the sale, donated items, the target charity may realize much more from sale than they would if they attempted to sell the property in their locality.

In accordance with the present invention, a method for donating the proceeds from the sale of physical assets to a charity comprising the following steps: providing an interface for an end user donor to place an item for sale by a first charity and in which a second charity designated charity is identified to receive the proceeds; providing an interface for a purchaser to purchase the item and remitting the funds to the first charity and providing the donor with a receipt; and providing a means whereby the first charity can remit the proceeds to the second charity designated charity.

In a further embodiment, the invention is a method for donating the proceeds from the sale of physical assets or personal property to a designated charity comprising the following steps: providing an interface associated with an intermediate charity for an ultimate designated charity to register itself on the system; providing an interface associated with an intermediate charity for an end user donor to place an item for sale and for designating that the ultimate designated charity is to receive the proceeds; providing an interface for a purchaser to purchase the item through the intermediate charity and providing the donor with a receipt; and providing the intermediary charity with the proceeds which are then remitted to the designated charity upon receipt of evidence by the intermediate charity that the item was shipped.

In still a further embodiment, a-method for donating the proceeds from the sale of physical property to an ultimate charity comprising the following steps: providing an interface associated with an intermediate charity for a plurality of ultimate charities to register themselves on the system on the system; providing an interface associated with an intermediate charity for an end user donor to place an item for sale, the proceeds of which may be design to one of the plurality of ultimate charities or to an additional designated charity added by the donor; providing an interface associated with the intermediate charity for a purchaser to purchase the item providing the donor with a receipt; and providing the intermediary charity with the proceeds which are then remitted to the designated ultimate charity upon evidence of delivery of the item to the purchaser.

One of the critical features of the attributes of the invention is that that the donated physical asset, while never being delivered to the intermediary, will belong to the intermediary immediately and the value of the donated property may be deducted as a charitable contribution immediately.

It is to be noted that the sale procedure established by the intermediary may assist in the determination of the fair market value of the asset. If the asset is not sold through the auction process, the donor will be instructed to dispose of the property on behalf of the intermediary. This concept is necessary in order to preserve the integrity of the donation process and the resulting tax deduction.

### BRIEF DESCRIPTION OF THE FIGURES

FIG. 1 is a block diagram of the electronic commerce enable purchaser uniform purchase system in accordance with the present invention

FIG. 2 is a block diagram of the end user and server systems in accordance with the present invention.

FIG. 3 illustrates the database architecture of the present invention.

FIGS. 4-9 illustrates a series of interface user screens for the use of the system of the present invention.

### DETAILED DESCRIPTION OF THE INVENTION

The present invention facilitates the transfer and sale of physical items via a novel internet Interface to a 501(c)(3) organization which is established to legal title receive and distribute the proceeds from sold donated property. The intermediary can then automatically sell the assets to third party purchasers and redirect the cash proceeds according to the instructions of the donor. The present invention is specifically directed to a comprehensive computerized system for facilitating the sale of assets for charities whereby donors can sell and control the sale of personal items to designated end user purchasers and the like. The system automatically makes the sale, forwards the proceeds to the charity and issues the appropriate documentation to the donor.

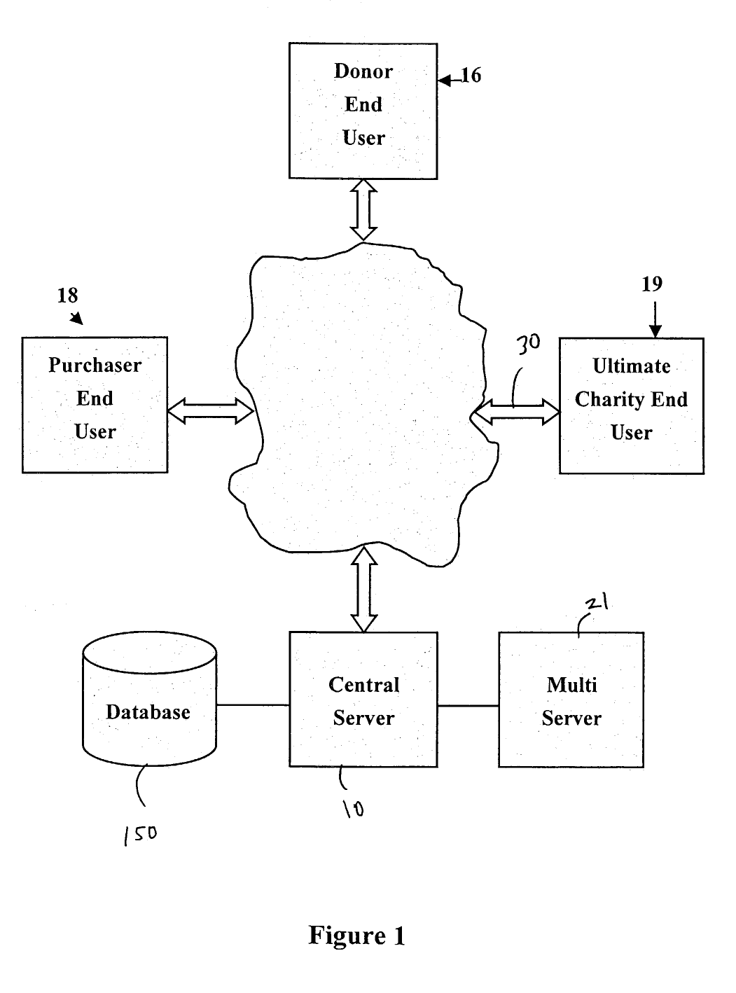

Referring to FIG. 1, a most preferred embodiment of the present invention is disclosed and shown. As will be discussed herein, the present invention is directed to an online system and technology whereby donors may legally transfer physical items or property to an intermediary charity to be sold whereby an ultimate charity can derive benefit by receiving the ultimate proceeds. In the most preferred embodiment, the technology may be enabled through an online web technology.

From a structural and operational standpoint, the most preferred embodiment comprises a central computer server 10 connected by a computer network 12 to remote end user stations 14. The central server connects to a database 150. In a preferred embodiment, end user stations 14 comprise a plurality of end user donor purchasers 18 and ultimate charities 19 linked via a transport medium 30. The charities 19 comprise the charities which will receive the proceeds derived from the sale of the donated property.

The central server also provides a list of the applicable charitable organization. As noted, central server in one embodiment contributes a website such as www.generousgent.com, which will host a website which controls the sale of the property. For the purpose of this disclosure, the website is associated with an intermediate charity under §§503(c) of the U.S. Tax Code such as Generousgent.com.

Donors and purchasers as noted above, in a most preferred embodiment, will be linked via a global computer network 12 such as the internet or worldwide web, but other embodiments including LANs, WANs and Intranets, fulfill the spirit and scope of the present invention. Both donor, purchaser, and the charities 16, 18, 19 will typically use any device that connects to the system via the Internet or other IP transport methods and includes, but is not limited to, such devices as televisions, computers, hand-held devices, cellular phones, land based telephones, wireless electronic devices and any device which uses a transport medium 30.

Non-limiting examples of a transport medium 30 applicable for use in the present invention comprise any backbone or link such as an ATM link, FDDI link, satellite link, cable, cellular, twisted pair, fiber optic, broadcast wireless network, the internet, the worldwide web, local area network (LAN), wide area network (WAN), or any other kind of intranet environment such a standard Ethernet link. In such alternative cases, the clients will communicate with the system using protocols appropriate to the network to which that client is attached. All such embodiments and equivalents thereof are intended to be within the scope of the present invention.

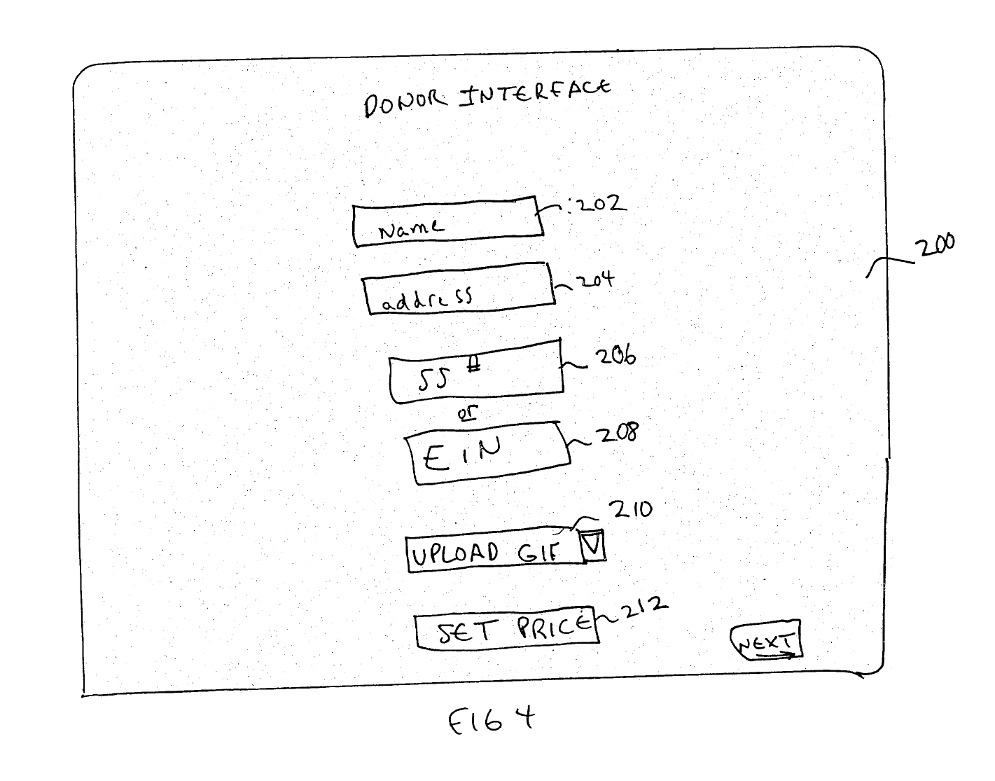

Referring again to FIG. 1, the present invention may comprise a multi-server 21 environment which comprises a computer system in accordance with the present invention that allows the multiple users 16, 18, 19 to communicate with the system. Through communication link and transport medium 30, donors and purchasers 16, 18 and the ultimate charity 19 will be linked to the central server 10, preferably by a customizable interface to be described in greater detail below at FIGS. 4 to 9.

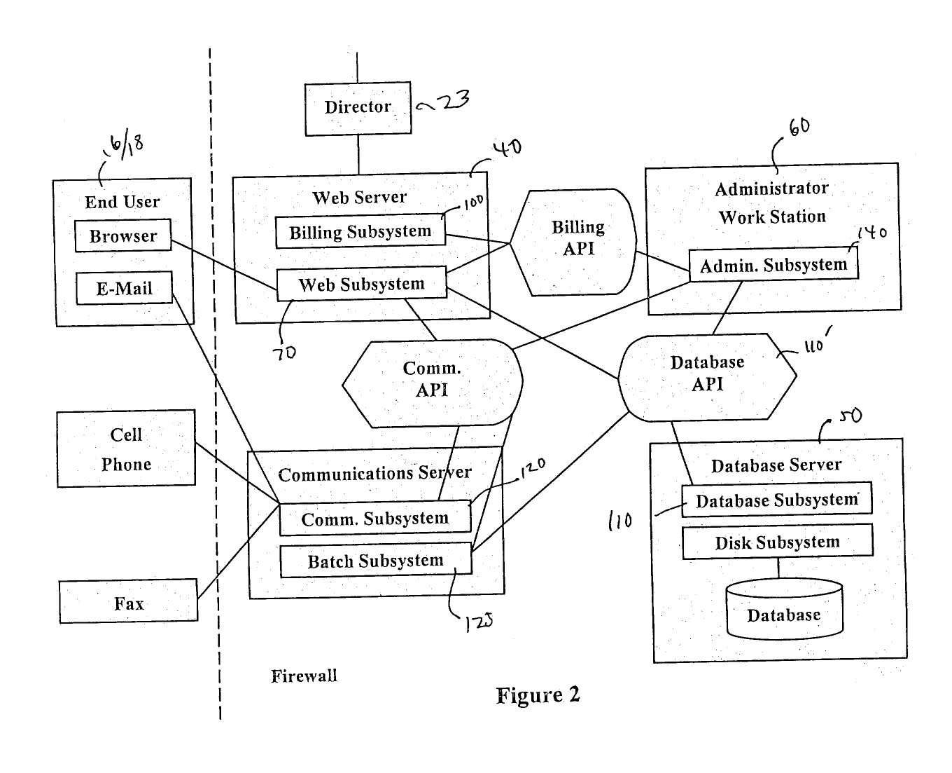

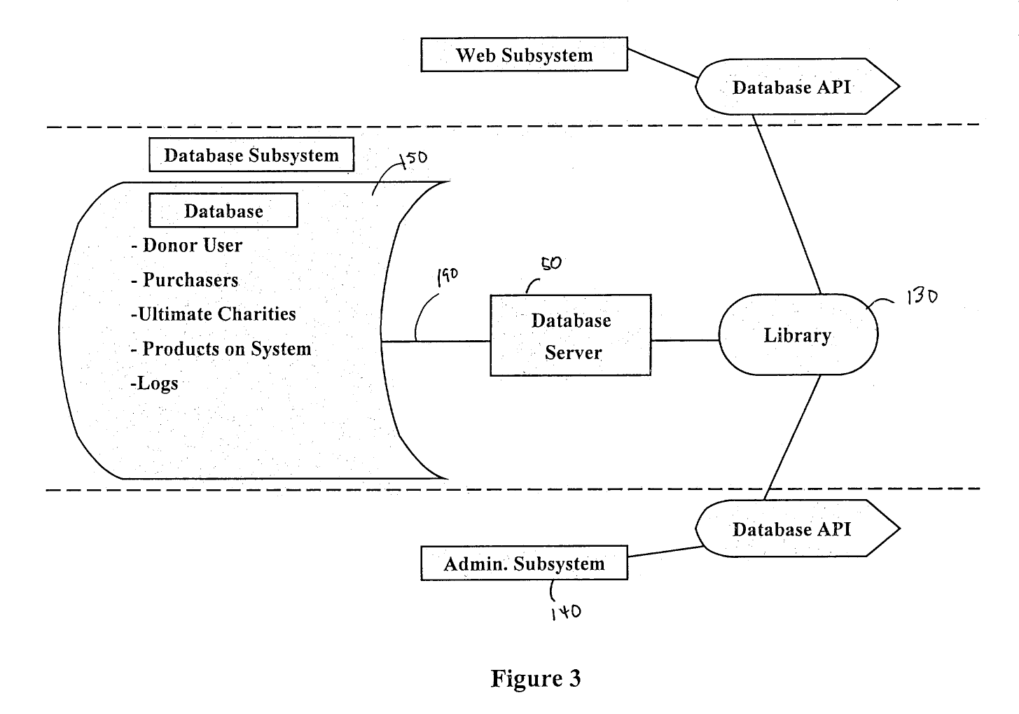

Referring to FIGS. 2 and 3, the central server and database systems of the present invention are now shown and described in greater detail. A local director 23 routes signals through the system to the various servers, to be described below, and to and through transport medium 30 to the donors and purchasers. The system preferably includes two primary servers, a web server 40 and a database server 50 which may operate using such database platforms as SQL server or Oracle. Hence, in one embodiment the SQL server may run SQL server database management software from Microsoft Corporation. Alternatively, the server can further comprise an Oracle database server.

The system further includes an administrative work station 60 or system which provides administrative capabilities and monitoring for the system under the control of an administrative subsystem 140. The administrative work station 60 allows administrators or other operators to perform routine operations which affect the entire system. Such operations include, but are not limited to, administering the accounts of donors, back end functions, adding or deleting new users as donor website accounts, purchaser and donors, the issuance of checks to charities, the tabulation of printing reports and performing of backups and maintaining the programs that comprise the overall system

A web subsystem 70 is responsible for all interactions with a web browser 80 in the devices 16, 18 and serves as the end user interface to the system. All interactions between the devices 16, 18 and the database subsystem occur through the web subsystem 70. Internet Information Server 200 (IIS) by Microsoft Corporation is an exemplary web server software system 70 in accordance with the present invention, although the present invention is in no way limited to this system. The expression of the user interface presented to users 16, 18 in their client devices may be implemented as HTML or other high level computer language or technology, and may be displayed in a standard web browser including a wireless browser.

All systems listed above are preferably communicated via an Ethernet 100 base T network and a switching hub. In addition, a second isolated network segment will preferably exist between the web server 40 and the external communications hardware (e.g. internet router). Such a system will keep external traffic isolated from the internal network, as well as providing a dedicated connection between the web server 40 and the internet for maximum throughput. The systems will have an initial configuration of random access memory for the web server 40 and preferably at least 128 megabits for the database server 50, both having the capability to expand.

The web server 40 is the point of entry to the entire system. The system determines the identity of the donors and purchasers 16, 18 and makes appropriate decisions while serving web pages to the users 16, 18. The web server 40 sends HTML or other high level computer language to the end user work stations 16, 18, validates passwords, sends logging and transaction information to the database server 50, and performs logical operations, thus behaving as a transactional server.

As noted above, in one embodiment, the server operating system may be a Windows NT server, a multi-platform operating system provided by Microsoft Corporation. The Sun Microsystems Solaris is an alternative embodiment. The server typically includes IIS, which is a completely integrated internet application platform. IIS includes a high-performance web server, an application development environment, integrated full-text searching, multi-media streaming and site management tools. The security infrastructure is integrated within the server, thus enabling an easy-to-maintain and highly-secure web development and deployment environment.

The operators of the system may create, delete and update account information by utilizing the administrative subsystem 140 in administrator work station 60. A billing subsystem 100 is responsible for credit card, debit card or checking account verification and any necessary billing type functions. The billing subsystem holds the monies sent by the purchaser until the goods are shipped and confirmed.

Database 110, communication 120 and billing 100 subsystems thus execute essential services for the other parts of the system, and will therefore have well-defined application program interfaces (API) 110′, 120′, 100′, as is well recognized by those with skill in the art. The system will preferably be protected for the Internet by a “firewall” 90 which is a safety precaution, and important with respect to the present invention due to the sensitive and confidential nature of some of the material in the database.

In a preferred embodiment, the database subsystem 110 stores all pertinent information pertaining to donator and purchaser accounts, transactions, and account history as well as general dynamic system information. All interactions with the database subsystem 110 are performed through a database API 110′ which may define the interface to a library of stored procedures 130. These are used to implement high-level database functions and to shield the details of the database implementation from the other subsystems. The database subsystem 110 is preferably implemented using database server 50. The database contains such information as user information, the inventory of all items available for sale at donator storefronts, sales history, collections and item descriptions.

The administration subsystem 140 provides an interface for operators and managers of the system to modify the database, print reports, view system data and log user information. The administration subsystem 140 provides a collection of access forms, queries, reports and modules to implement the administration interface. Administrators typically will have the power within the system to force most actions. The administration subsystem 140 will interact with the communications, database and billing subsystems.

The communications subsystem 120 interfaced to a communications API 120′ will be used to notify both donors and purchasers 16, 18. Donor/Purchaser 16, 18 may be notified by phone, fax, email or pager, or other communications devices which can be contacted by the system 135. Some portable telephones and pagers include email addresses and so may be contacted by the email system; other users have only phone numbers. Other interfaces may be utilized as the application so demands.

A batch subsystem 125 may periodically send out grouped notifications. It will access the database subsystem 110 to determine what notifications are required, and uses the communication subsystem 120 to make those notifications. The billing subsystem 100 may be used to verify and bill credit cards, where applicable, and communicate through the billing API 100′ to the administration subsystem 140, and potentially to an outside billing and verification service which could be used to perform the billing functions.

Referring to FIG. 3, the database server 50 which implements the database subsystem 110 of the present invention comprises a server that maintains all associated logging and transaction information for the system. Through the database 150 (which is backed up by a backup database for safety purposes), the database server 50 logs donator and purchaser setup, account creation information, store inventory, maintains and tabulates transactions and collections, hosts backup operations and performs statistical calculations for the entire system.

The database server 50 is preferably a dual processor computer microprocessor. Each connection to the database 150 and its associated work may be handled by a separate thread within the database server 50 processor space. It is anticipated that a dual processor machine is sufficient for the type and amount of transactions that it will be performing, however if it proves insufficient, the database can be “striped” to two or more machines to distribute the server load.

The disk subsystem 190 of the database server may comprise a vulnerable and crucial server element. Due to the mission critical design of the subsystem, it is preferable to utilize a Level 5 RAID. RAID is an alternative to standard SCSI hard disk drives. A RAID system provides automatic recovery from hard drive failures. Level 5 RAID systems provide the best balance between cost and level of data protection. A Level 5 RAID system uses multiple hard disk drives, on which the stored data is recorded redundantly using a scheme by which the data on the disk can be reconstructed if one of the disk drive units in the RAID fails. In the event of failure, the failed drive can be removed from the RAID system while it is still operating, and a replacement drive can be installed. The RAID system will regenerate the data and return itself to full protection capability. The data sorted on the disk subsystem remains available for normal processing, that is, from the time the drive fails to the time the RAID system is returned to full protection capability. Other levels of RAID which are less costly do not offer this type of data availability and could translate into costly system downtime.

Statistical calculations will be performed by the database server 50, along with other types of report generation. Specifically, IIS can log directly to an Open Database Connectivity (ODBC) standard data source. This makes the availability of the data collected by the database server about client activity on the system more readily available and easier to process into logical reports. Preferably the database server system is configured with a dual P6 CPU, 128 MB ECC, having sufficient ECC RAM, a graphics adapter capable of showing 1024×768 pixels with a depth of 8 bits, a 15 inch monitor, a PCI Fast/Wide SCSI-2 I/0 adapter, one PCI 100base T Ethernet adapter, a keyboard and a mouse, a 3.5 inch floppy drive, a CD ROM Drive, a disk drive, a 2 GB PCI Fast/Wide SCSI-2 hard disk drive, two 9 GB PCI Fast/Wide SCSI hard drives (Level 1) or an 8 GB RAID Subsystem (Level 5), and a 24 GB DAT SCSI (2 MB per minute) tape back-up unit.

In one embodiment, there will be one operator workstation 60 used for administering the system. As the need for additional workstations arises, additional operator workstations can be added by adding additional computer systems, installing the administration software and connecting them to the LAN. Operator workstation machines preferably utilize a Windows operating environment manufactured by Microsoft Corporation.

In view of the above operational environment, the present invention is now described in the context of a web-based system for facilitating the creation of an online solution for selling property and remitting the balance to charity. The present invention, in a most preferred embodiment, is specifically directed to a dual sided solution in which individuals (purchasers) who desire to purchase donor listed assets can do so in a virtual environment and the proceeds can be issued to an ultimate charity.

As noted, the system utilizes the world wide web or global communications network to advertise for sale, donated items. The target or ultimate charity may realize much more from sale than they would if they attempted to sell the property in their locality.

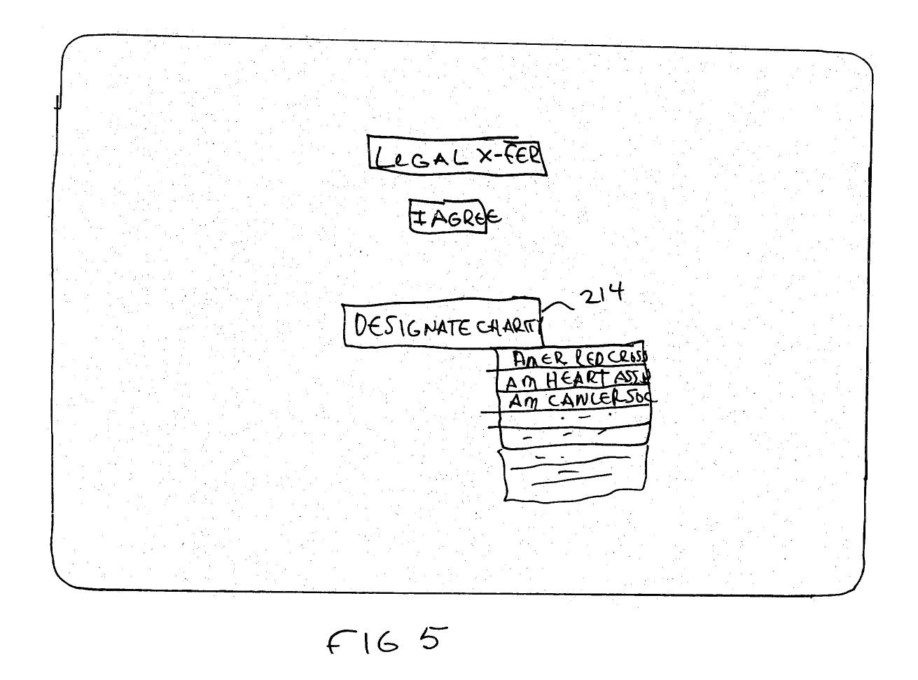

As shown in FIGS. 4-5, the end user donor 16 is provided with an interface 200 in which the donor can place an item to be sold. FIG. 4 illustrates the main screen of the system. As shown in FIG. 44, the donor end user is provided with an interface. The interface includes a location for the donors name 202 address, 204 social security number 206 and/or tax ID number 208. The donor user can then identify the item to be sold including a picture such as a JPE6 or GIF file 210. The item can then be priced 212. Alternatively, the item can be offered to the highest bidder.

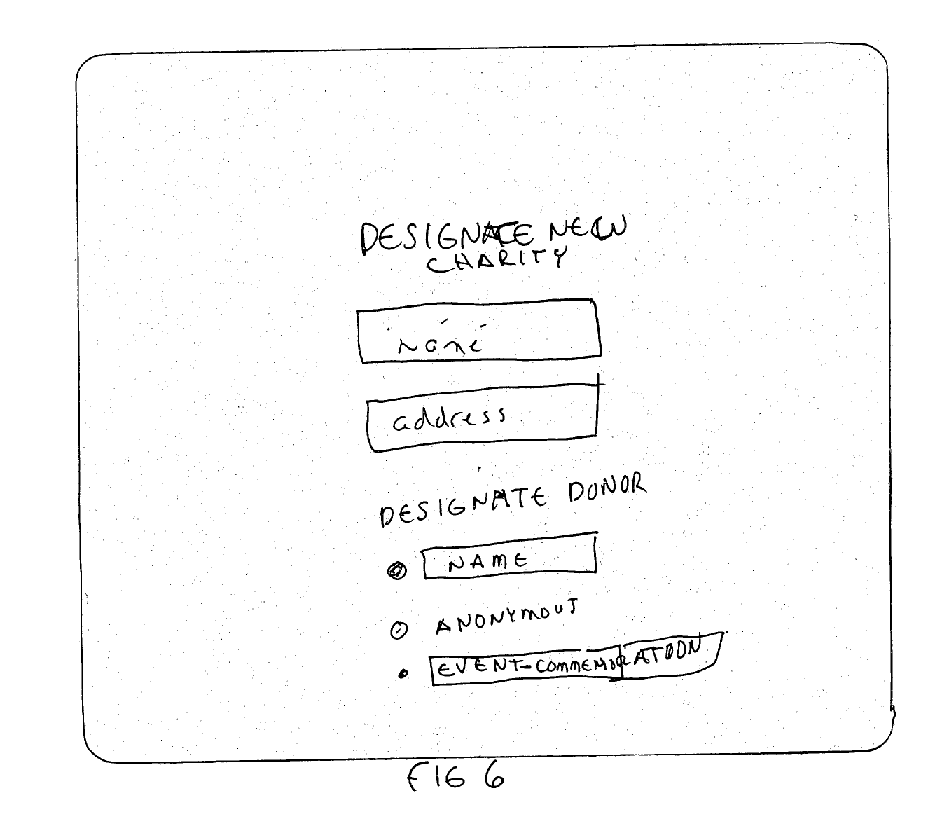

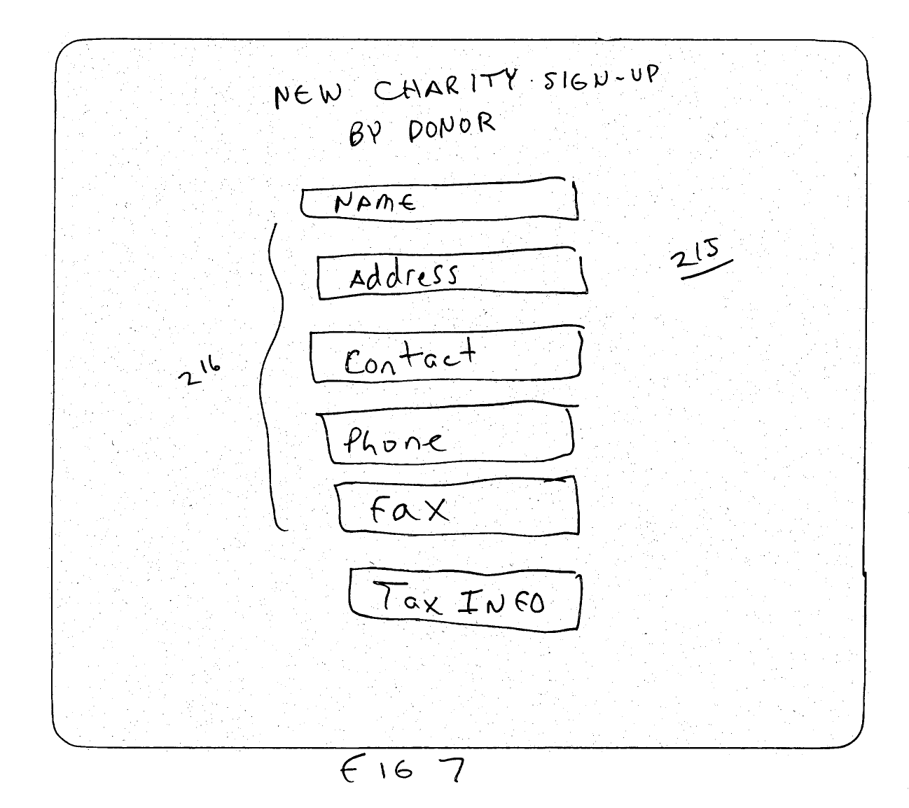

Referring to FIG. 5, the item is legally donated to the intermediate charity by means of a transfer. The interface then includes a location 214 where the donor can designate the name of the ultimate charity to receive the proceeds. The charity can comprise an existing member charity selected from a pull down menu or as shown in FIG. 6, a new charity can be designated 215. FIG. 7 illustrates a fill in form 216 whereby the new charities basic information can be input.

The donor can indicate whether the donation is to be anonymous 218 or the donor can indicate an occasion to be honored (e.g., “Gift Honoring First Holy Communion of John Doe, Jr.”). As noted, the ultimate charity may comprise a series of prescreened and preselected charities such as the American Red Cross, American Cancer Society, etc or the donor identifying and input a charity.

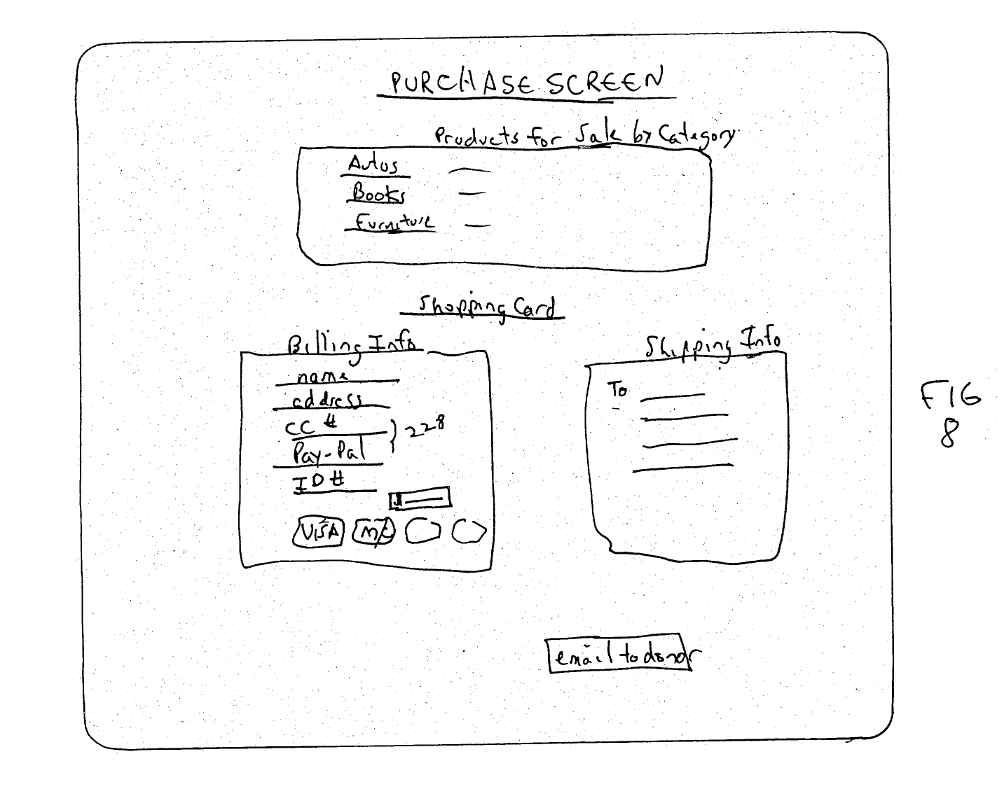

The intermediate charity posts it and purchaser sees the product from a list of assets or property place for sale. Each product may have a unique ID number. As shown in FIG. 8, the purchaser can then buy it. The purchase may be made through credit card, debit card or electronic cash 228. Once sold, the donor receives an email instructing him or her to ship the product pursuant to shipping instructions submitted by the purchaser. When the sale is made, and confirmation is made that the product is shipped, the ultimate charity 19 gets the proceeds. That is, when the product is shipped the money is released to the ultimate donee charity and the intermediary charity takes a small handling fee. A receipt is emailed to the donor.

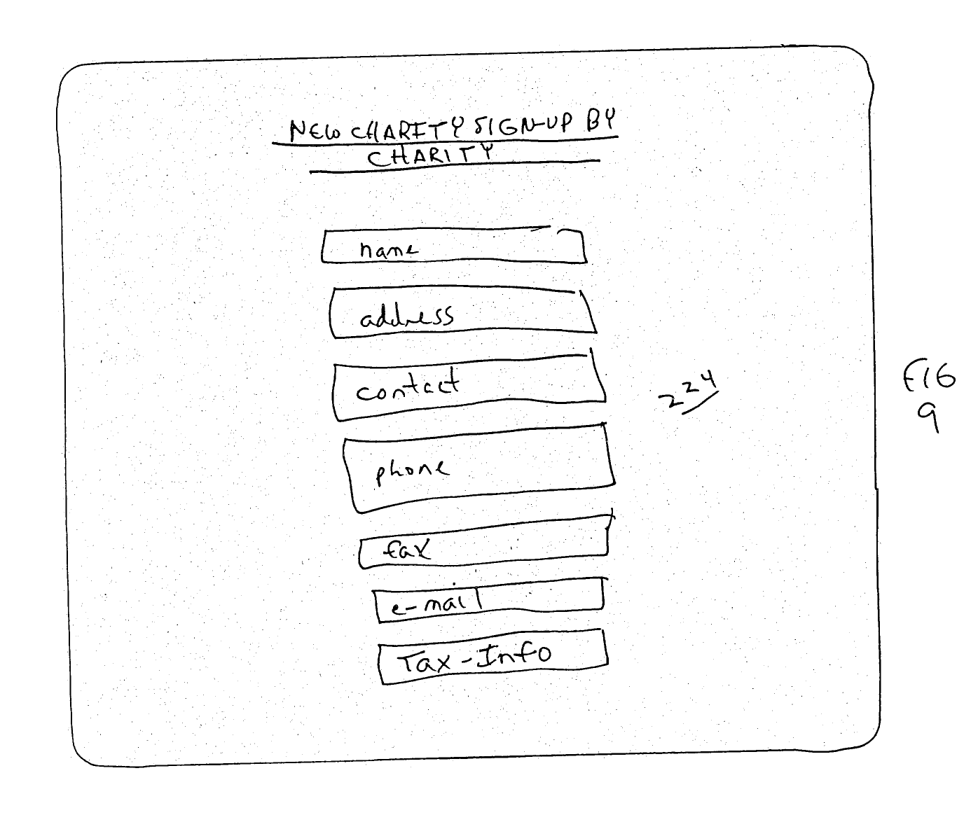

As shown in FIG. 9, an ultimate charity can also register as a user 222 for purposes of being added to the list of charities. FIG. 9 illustrates an input screen where the charity can designate itself as an ultimate charity by placing the appropriate tax and contact information 224 in order to receive the proceeds of the sale of any property.

In another embodiment of the present invention the donor may be allowed to specify the conditions under which the asset is given. For example, the donor may wish to control the price at which the asset is sold. One feature of the invention is to provide an auction. The benefits of the present invention accrue to multiple groups, including individuals, financial institutions, donor advised organizations and charities.

The present invention provides increased convenience in giving to charities. They have more informed decisions regarding the best asset to sell. This automates and increase tax savings resulting from gifts of appreciated assets. The system generates a tax receipt, based upon the asset transfer, for the donor 16. Appropriate tax forms are also generated evidencing the gift and forwarded to the donor for his records. The system also automatically generates “thank-you” letter to the donor in the name of the ultimate charity 19.

The present invention provides donors with a simple, straightforward way to maximize their giving to charity by giving more conveniently. The invention provides the charity with the ability to obtain the proceeds without having to take possession of the property or sell it. This process is extremely easy to use with minimal time required for the entire transfer process, eliminating one of the primary hindrances currently keeping individuals donating appreciated assets.

One of the critical features of the attributes of the invention is that that the donated physical asset, while never being delivered to the intermediary, will belong to the intermediary immediately and the value of the donated property may be deducted as a charitable contribution immediately.

It is to be further noted that the sale procedure established by the intermediary may assist in the determination of the fair market value of the asset. If the asset is not sold through the auction process, the donor will be instructed to dispose of the property on behalf of the intermediary. This aspect is necessary in order to preserve the integrity of the donation process and the resulting tax deduction.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for donating the proceeds from the sale of physical assets to a charity comprising the following steps:
providing an interface for an end user donor to place an item for sale by a first charity and in which a second charity designated charity is identified to receive the proceeds;
providing an interface for a purchaser to purchase the item and remitting the funds to the first charity and providing the donor with a receipt; and
providing a means whereby the first charity can remit the proceeds to the second charity designated charity.

2. The method of claim 1 wherein the first charity remits the funds to the second designated upon receipt of confirmation that the physical assets were shipped to the purchaser.

3. A method for donating the proceeds from the sale of physical assets or personal property to a designated charity comprising the following steps:
providing an interface associated with an intermediate charity for an ultimate designated charity to register itself on the system;
providing an interface associated with an intermediate charity for an end user donor to place an item for sale and for designating that the ultimate designated charity is to receive the proceeds;
providing an interface for a purchaser to purchase the item through the intermediate charity and providing the donor with a receipt; and
providing the intermediary charity with the proceeds which are then remitted to the designated charity upon receipt of evidence by the intermediate charity that the item was shipped.

4. The method of claim 3 further comprising the step of automatically generating a thank you letter to the donor.

5. A method for donating the proceeds from the sale of physical property to an ultimate charity comprising the following steps:
providing an interface associated with an intermediate charity for a plurality of ultimate charities to register themselves on the system on the system;
providing an interface associated with an intermediate charity for an end user donor to place an item for sale, the proceeds of which may be design to one of the plurality of ultimate charities or to an additional designated charity added by the donor;
providing an interface associated with the intermediate charity for a purchaser to purchase the item providing the donor with a receipt; and
providing the intermediary charity with the proceeds which are then remitted to the designated ultimate charity upon evidence of delivery of the item to the purchaser.
